(19) United States
(12) Patent Application Publication
(10) Pub. No.: US 2021/0387419 A1
(43) Pub. Date: Dec. 16, 2021

(54) BUILD MATERIAL THERMAL VOXEL BASED ADDITIVE MANUFACTURING ADJUSTMENTS

(71) Applicant: Hewlett-Packard Development Company, L.P., Spring, TX (US)

(72) Inventors: Chandrakant Patel, Palo Alto, CA (US); Jun Zeng, Palo Alto, CA (US)

(73) Assignee: Hewlett-Packard Development Company, L.P., Spring, TX (US)

(21) Appl. No.: 17/047,306

(22) PCT Filed: Aug. 9, 2018
(86) PCT No.: PCT/US2018/046119

§ 371 Date: Oct. 13, 2020

(51) Int. Cl. B29C 64/393; B29C 64/165; B29C 64/295; B33Y 10/00; B33Y 30/00; B33Y 50/02

(52) U.S. Cl. CPC B29C 64/393; B29C 64/165; B33Y 50/02; B33Y 10/00; B33Y 30/00; B29C 64/295

(57) ABSTRACT

In one example in accordance with the present disclosure, a method is described. According to the method, profile information is acquired for a layer of a volume of build material in an additive manufacturing system. From the profile information, a per thermal voxel attribute of build material particles is approximated. An operation of the additive manufacturing system is adjusted based on an approximated per thermal voxel attribute.

### BACKGROUND

Additive manufacturing machines produce three-dimensional 3D objects by building up layers of material. Some additive manufacturing machines are referred to as “3D printing devices” because they use inkjet or other printing technology to apply some of the manufacturing materials. 3D printing devices and other additive manufacturing devices make it possible to convert a computer-aided design CAD model or other digital representation of an object directly into the physical object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an additive manufacturing system with thermal voxel based adjustments, according to an example of the principles described herein.

FIG. 2 is a flowchart of a method for thermal voxel based additive manufacturing adjustments, according to an example of the principles described herein.

FIG. 3 is a diagram of an additive manufacturing system with thermal voxel based adjustments, according to an example of the principles described herein.

FIG. 4 is a block diagram of an additive manufacturing system with thermal voxel based adjustments, according to another example of the principles described herein.

FIG. 5 is a flowchart of a method for thermal voxel based additive manufacturing adjustments, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Additive manufacturing devices make a 3D object through the solidification of layers of a build material on a bed within the device. Additive manufacturing devices make objects based on data in a 3D model of an object generated, for example, with a CAD computer program product. The model data is processed into slices, each slice defining a layer of build material that is to be solidified.

Additive manufacturing may take a variety of forms. For example, in a multi jet fusion operation, an agent is dispensed onto a layer of build material such as a fusible material in the desired pattern. The agent disposed in the desired pattern increases electromagnetic energy of the underlying layer of build material on which the agent is disposed. The build material is then exposed to electromagnetic radiation. The electromagnetic radiation may include infrared light, laser light, or other suitable electromagnetic radiation. Due to the increased heat absorption properties imparted by the agent, those portions of the build material that have the agent disposed thereon heat to a temperature greater than the fusing temperature for the build material.

Accordingly, these portions of the build material fuse together to form a solid layer that makes up a portion of the object to be printed. Those portions of the build material that receive the agent and thus have increased heat absorption properties may be referred to as fused portions. By comparison, the applied heat is not so great so as to increase the heat of the portions of the build material that are free of the agent to this fusing temperature. Those portions of the build material that do not receive the agent and thus do not have increased heat absorption properties may be referred to as unfused portions. Accordingly, a predetermined amount of electromagnetic energy is applied to an entire bed of build material, the portions of the build material that receive the agent, due to the increased heat absorption properties imparted by the agent, fuse and form the object while the unfused portions of the build material are unaffected, i.e., not fused, in the presence of such application of thermal energy.

Heating of the build material may occur in two processes. In a first process, the build material is heated to and maintained at a temperature just below the build material fusing temperature. In a second process, an agent is “printed” or otherwise dispensed onto the build material in the desired pattern and exposed to another, relatively, higher intensity electromagnetic radiation source. This relatively higher intensity light is absorbed into the patterned agent causing the underlying build material to fuse. Halogen lamps emitting light over a broad spectrum may be used in both these processes. While specific reference is made to multi jet fusion, other types of additive manufacturing operations exist as well.

In a heat sintering/melting operation, heat is applied to layers of a powder material in a particular pattern. The applied heat sinters, or joins adjacent powder particles to form a solid layer while other particles that do not receive the applied heat remain as a powder. Thus, for each layer, a pattern of adjoined particles is formed. Successive hardened layers form a 3D printed object.

While additive manufacturing systems have undoubtedly enhanced 3D printing operations such that they are accessible to a wider audience, enhancements to their performance may serve to increase their use in society. For example, increased yields may make additive manufacturing use more effective. A yield of an additive manufacturing operation refers to the quantity of finished products that meet quality standards specified by a user. Variation among the finished products, i.e., variations in geometry, physical characteristics, etc., that is so great as to not be within the bounds of the quality standards specified by a user reduces the yield and is therefore unacceptable. Accordingly, ensuring a satisfactory yield, i.e., printed objects meeting the specified quality standards, may increase the overall quality of additive manufacturing systems and could lead to their increased use. Increasing production yield is especially relevant given the ever expanding use of additive manufacturing devices with printed object counts ranging from the dozens to thousands.

Product uniformity is affected by any number of factors. One particular factor relates to the characteristics of the build material particulate matter; and more specifically to the thermal history of the build material. That is, over the course of additive manufacturing, the particles of the build material are exposed to different temperatures, which alter the state of the particles differently. If different particles of the build material are exposed to different temperatures from one another their history profile may look different from the temperature history profiles of other particles. That is, different particles may be in different states at different points in time.

As the characteristics of a finished product are based at least in part on the thermal history profile of the build material, differences in the thermal history profile across the finished product may result in non-uniformities within the finished product. For example, build material particles that have a different thermal history may have different functional irregularities such as built in thermal stress. Still further, the defining characteristics of a finished product are based on the thermal history of the particulate build material. For example, the tensile strength, elongation at break, and yield strength are defined in part by the thermal history of the particulate build material. Accordingly, particles with different thermal history profiles may, if the differences are significant enough, result in a finished product with non-uniform properties. Non-uniform properties may result in any number of defects including part warping, degraded structural strength etc. In other words, thermal history gradients introduce uncertainty into the additive manufacturing process, which uncertainty may result in defects that can push the product outside of the specified quality thresholds and in some cases may pose a danger.

The temperature history is dependent at least in part on the thermal energy transfer of the particles. There are many different forms of thermal energy transfer. For example, particulate matter may gain energy due to absorption via the fusing agent. Particulate matter may lose energy due to evaporation. Other examples of energy transfer that affect the thermal history of particulate matter includes thermal diffusion to adjacent particulate matter. As yet another example, energy loss may result from airflow (both advection due to flow and natural convection).

Different particles may collect or lose thermal energy at different rates based on different physical characteristics. For example, particulate matter on the surface of the bed may lose heat due to convective air flow whereas particles on a lower layer of the bed experience no such convective heat loss. Moreover, particulate matter near an edge of a build material volume may experience more or less heat transfer due to its presence near a bed wall. It does not take much to imagine all the ways in which the thermal energy transfer among the individual particles of a build material layer may vary. As described above, such variation can, if to a sufficient amount, alter part quality.

Accordingly, the present specification describes an additive manufacturing system and method to increase a device yield by precisely controlling the thermal characteristics of an additive manufacturing device at a high resolution. Specifically, the present specification increases 3D part uniformity by more closely aligning the thermal history profile of the build material. That is, end-part functional quality will be more uniform as the thermal history profile of the build material is stable. Doing so results in similar functional irregularities and characteristics of the product. Specifically, the present specification estimates different attributes of particulate matter. Based on a relationship between these attributes and energy transfer, an operation of the additive manufacturing system is adjusted to more closely align the thermal profile across a layer of the build material.

Specifically, according to the present specification, the layer of the build material is divided up into regions. For each region, a build material particulate attribute is approximated. From this approximation, it can be determined how additive manufacturing within that particular region should be adjusted. For example, it may be the case that heaters are amplified to apply more thermal energy. In another example, the amount of build material may be increased or decreased. In yet another example, it may be the case that more energy-absorbing agents are applied to raise the heat energy of a particular powder region.

Accordingly, the present specification describes a method. According to the method, profile information is acquired for a layer of a volume of build material in an additive manufacturing system. From this profile information, a per thermal voxel attribute of build material particles is approximated. From such an approximation, an operation of the additive manufacturing system is adjusted.

The present specification also describes an additive manufacturing system. The additive manufacturing system includes a build material distributor to successively deposit layers of build material onto a bed, which bed holds a volume of build material. At least one heater, in a layer-wise fashion, selectively heats portions of the build material to form an object via the application of heat to the build material in the bed. A profile determiner of the system determines a profile for a layer of a volume of the build material. A controller of the system then approximates from the profile information, a per thermal voxel attribute of build material particles. The controller also adjusts an operation of the additive manufacturing system based on an approximated per thermal voxel attribute.

According to another example method, a thermal voxel size is determined based on a thermal energy transfer mechanism for an additive manufacturing system. Then, during additive manufacturing, profile information is acquired and a per thermal voxel attribute of build material particles determined therefrom. For each thermal voxel, a thermal diffusivity is determined, from which an operational adjustment can be determined. An operation of the additive manufacturing system can then be adjusted accordingly.

In summary, using such an additive manufacturing device 1) provides real-time sensing data used for additive manufacturing adjustment to ensure thermal uniformity across a surface of the build material volume; 2) provides closed-loop feedback for the additive manufacturing device; 3) provides a more stable sintering/heating process; 4) is customizable per material and additive manufacturing system characteristics; and 5) does not result in sacrificial parts. However, the devices disclosed herein may address other matters and deficiencies in a number of technical areas.

As used in the present specification and in the appended claims, the term “thermal voxel” refers to a region whose dimension is comparable to a characteristic length of a thermal effect of interest. Put another way, a thermal voxel refers to a region wherein a variation in a thermal effect of interest is negligible.

Further, as used in the present specification and in the appended claims, the term “device voxel” refers to a region defined by hardware capabilities and represents the maximum resolution that the additive manufacturing device can achieve. That is the device voxel defines the minimum hardware spatial addressability and is based in part by the components of the additive manufacturing system.

Even further, as used in the present specification and in the appended claims, the term “attribute” refers to one of any number of characteristics of a thermal voxel that affect thermal energy transfer. Examples of such attributes include packing density, surface area, surface energy, particle size/shape distribution, and exposed surface area.

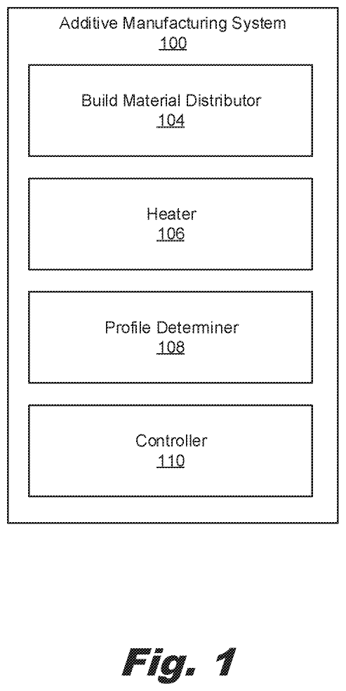

Turning now to the figures, FIG. 1 is a block diagram of an additive manufacturing system (100) with thermal voxel based adjustments, according to an example of the principles described herein.

The additive manufacturing system (100) includes a build material distributor (104) to successively deposit layers of build material onto a bed, which bed is to hold a volume of build material. Various types of build material may be used in the additive manufacturing system (100). In one example, the build material is a fusible material. With a fusible material, particulate matter fuses together when the particulate matter reaches a fusing temperature. One example of a fusible material is polyamide 12, which has a fusing temperature of approximately 185 degrees Celsius. In this example, portions of the polyamide 12 that are heated above its fusing temperature fuse together to form a solid object. While specific mention is made to polyamide 12 as a fusible build material, other build materials may be used, including, but not limited to polyamide 11 fusible materials or materials used in laser sintering and laser melting additive manufacturing operations.

The build material is deposited in the bed in layers. Each layer of the build material that is hardened in the bed forms a slice of the 3D printed object such that multiple layers of hardened build material form the entire 3D printed object. The bed may accommodate any number of layers of build material. For example, the bed may accommodate up to 4,000 layers or more. In an example, a number of build material supply receptacles may be positioned alongside the bed. Such build material supply receptacles source the build material that is placed on the bed in a layer-wise fashion.

The build material distributor (104) may acquire build material from the build material supply receptacles, and deposit such acquired material as a layer in the bed, which layer may be deposited on top of other layers of build material already processed that reside in the bed.

In such an operation, a build material distributor (104) passes over the bed and deposits layers of build material in the bed. In the case of a multi jet fusion device, a printhead then passes over the bed to selectively deposit an agent on selected portions of the build material that are to form the 3D printed objects. The portions that receive the agent, which are also referred to as the fused portions of the build material, absorb more heat energy. The increased absorption exhibited by the fused portions of the build material absorb sufficient heat from the heater such that these fused portions surpass the fusing temperature of the build material while the unfused portions to not absorb sufficient heat from the heater to surpass the fusing temperature of the build material. As the fused portions have surpassed the fusing temperature, the fused portions of the build material fuses together to form a solid 3D printed object.

The additive manufacturing device (100) also includes at least one heater (106) to, in a layer-wise fashion, selectively heat and solidify portions of the build material to form an object via the application of heat to the build material. A heater (106) may be any component that applies thermal energy. Examples of heaters (106) include infrared lamps, visible halogen lamps, resistive heaters, light emitting diodes LEDs, and lasers. As described above, the heater (106) may apply thermal energy to the build material so as to heat portions of the build material past a fusing/sintering/melting temperature.

The additive manufacturing system (100) also includes a profile determiner (108) to determine a profile of a layer of the volume of build material in the bed. That is, each layer of the build material is made up of microscopic particles. The profile determiner (108) performs surface metrology to identify these build material particles. In some examples, the layer of the volume of the build material that is analyzed may have a finite thickness. For example, the thickness may be 80 microns.

The surface profile determiner (108) may be a high resolution scanner that can discern the individual build material beads that make up the layer of the build material. In some examples, the profile determiner (108) may be an optical profilometer. An optical profilometer can identify the beads based on reflected light off the build material. In some examples, the profile determiner (108) is moved across the surface of the build material. In other examples, the profile determiner (108) is stationary and performs metrology for the entire layer of the build material at the same time. While specific reference is made to an optical profilometer, any type of profile determiner (108) can be used to perform surface metrology on the layer of the build material.

The additive manufacturing system (100) also includes a controller (110) that performs various operations. For example, the controller (110) approximates from the surface profile information, a per thermal voxel attribute of build material particles. As described above, a thermal voxel refers to a region of space on the top layer of the build material. Within this space, a particular thermal effect, or multiple thermal effects, do not vary to a relevant degree. In some cases this indicates that the variation on the thermal effect(s) within this region are below a threshold amount, which may be specified by a user and which may reflect a desired print quality or uniformity. The dimensions of the thermal voxel may change based on a particular thermal effect. For example, a convection-based thermal voxel may be larger than an energy conduction-based thermal voxel on account of the differing transfer mechanisms of those processes.

Accordingly, the controller (110) takes the profile information collected via surface metrology from the profile determiner (108) and approximates an attribute within thermal voxels. The controller (110) may approximate any number of attributes. For example, the controller may approximate a packing density of the build material particles within the thermal voxel. Other examples of attributes that may be approximated include, a thermal voxel surface area, a thermal voxel surface energy, a thermal voxel particle size/shape distribution, and a thermal voxel exposed surface area. As described above, each of these attributes may be approximated at a per thermal voxel level. While specific reference is made to particular attributes that are approximated per thermal voxel, other attributes may be determined as well at a thermal voxel resolution.

As described above, approximating attributes of a thermal voxel allows for the selective adjustment of certain operational parameters of the additive manufacturing system (100) to allow for more uniform thermal profiles across the build material volume.

Approximating attributes per thermal voxel, as opposed to some other volume, enhances the efficiency and results of any resulting adjustments to the additive manufacturing system (100). For example, if a density were calculated across the entire surface of the build material, the collected density information may not have a high enough resolution to provide effective control. That is, a bed-wise density would not account for localized increases in density, such that any adjustments made would not account for the localized thermal properties. That is, if the approximated region is too large, collected data will not be sufficiently accurate to support fine tune control of additive manufacturing operations. By comparison, if an approximating region is too small, then the computational bandwidth to determine density and make adjustments may be prohibitive. Accordingly, selecting a thermal voxel size wherein a particular thermal effect can be considered as uniform provides a resolution sufficiently high to provide localized adjustments, but is not so small as to overburden the controller (110).

As described above, the controller (110) approximates these attributes because these attributes affect the thermal reactions of the build material. For example, the controller (110) approximates a packing density because packing density affects the thermal reaction of the build material. Knowing the packing density, it can be determined how particles within that region will thermally react and adjustments can be made to ensure desired thermal characteristics of the associated particles.

As another example, the controller (110) approximates the exposed surface area of a thermal voxel as exposed, or top layer surface area, affects heat loss via convective air flow. Knowing the exposed surface area, it can be determined how particles within that region will thermally react and adjustments can be made to ensure desired thermal characteristics of the associated particles.

The controller (110) also adjusts an operation of the additive manufacturing system (100) based on approximated per thermal voxel attributes. In some examples, the adjustments may be per thermal voxel. That is, the adjustments may differ between the different thermal voxels that make up the surface of the build material. In this fashion, localized attributes, and therefore localized thermal characteristics, allow for the generation of localized adjustments.

In some examples, the controller (110) may operate during additive manufacturing. More specifically, the controller (110) may approximate per thermal voxel attributes and may adjust an operation of the additive manufacturing system (100) while a 3D object is being printed. Accordingly, a real-time feedback system is implemented such that as successive layers are being deposited, the additive manufacturing operations are adjusted to ensure thermal energy transmission uniformity across the surface of the build material. In one specific example, after each layer of build material is deposited, 1) the profile determiner (106) performs surface metrology to determine the layer profile, 2) the controller (110) approximates a per thermal voxel attribute, and 3) the controller (110) adjusts the operation of the additive manufacturing system (100) per thermal voxel. These operations may be repeated per layer such that each layer of the 3D printed product is formed of build material that has a similar thermal profile, thus ensuring an enhanced quality product with more uniform properties.

Performing such operations per layer enhances product quality as there may be variation between particle attributes with each layer. This is because particulate matter is not uniform in size or shape and may also be due to the functioning of the build material distributor (104) which may not uniformly or perfectly distribute the build material. The present additive manufacturing system (100) accounts for this variation.

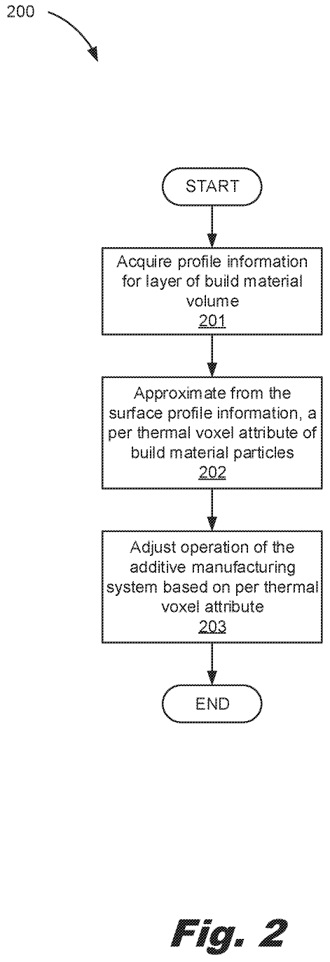

FIG. 2 is a flowchart of a method (200) for thermal voxel based additive manufacturing adjustments, according to an example of the principles described herein. According to the method (200), profile information is acquired (block 201) for a layer of a volume of build material in an additive manufacturing system (FIG. 1, 100). That is, as described above, a build material distributor (FIG. 1, 104) successively deposits layers of a build material on a bed of an additive manufacturing system (FIG. 1, 100). The surface of the layer is made up of the microscopic particles of the powder build material. Via surface metrology, the profile determiner (FIG. 1, 106) can individually identify the particles that make up the build material layer, doing so in a number of different ways. For example, an optical profilometer can emit interference signals and receive reflections of those signals. The characteristics of the received reflected signal are used to detect the individual powder particles that make up the build material.

From such information, a per thermal voxel attribute of the build material particles is approximated (block 202). As described above, examples of attributes that are approximated (block 202) per thermal voxel include surface area, packing density, exposed surface area, surface energy, and/or size/shape distribution, among others. As a specific example, a packing density is approximated (block 202) for each thermal voxel. Accordingly, for the entire bed, numerous attribute values, each corresponding to a thermal voxel that makes up the surface, are approximated.

As described above, a thermal voxel is defined as a region of space wherein a thermal energy transfer mechanism, or multiple thermal energy transfer mechanisms, do not change. As a specific example, a conduction-based thermal voxel refers to a region wherein the effects of conduction for example do not change more than a predetermined amount. Accordingly, the size of the thermal voxel is determined based on the particular thermal effect that is of interest. As noted above, in some examples, multiple thermal effects may be of interest. Accordingly, the size of the thermal voxel is reflective of each thermal effect considered. The thermal voxel defines a resolution by which adjustments are made to the operation of the additive manufacturing system (FIG. 1, 100). For example, the space within a thermal voxel will receive the same treatment from the additive manufacturing system (FIG. 1, 100), but adjacent thermal voxels may be treated differently, on account of the different thermal characteristics therein.

The attributes of the build material particles within the thermal voxel allow a determination of the thermal diffusivity of the material within the voxel. That is, there is a relationship between 1) attributes such as particle density, surface area, size/shape distribution and 2) thermal diffusivity. Once the attribute is calculated, or approximated, a thermal diffusivity can be determined. With the thermal diffusivity determined, adjustments can be made to the operation of the additive manufacturing system (FIG. 1, 100) to ensure that desired thermal characteristics result.

Accordingly, from the per thermal voxel attribute value, the additive manufacturing system (FIG. 1, 100) operation is adjusted (block 203), again per thermal voxel. Such adjustment may take many forms with the overall objective to establish a temperature profile for each thermal voxel that approximately matches one another within a specified amount. For example, in multi jet fusion, if certain regions absorb more energy through fusion, then those regions may subsequently receive less fusing agent. If other regions lose more heat energy via conduction, then those areas may receive more heat to counter the effects of conductive heat loss. As described above, the thermal voxel may be at least the size of a device voxel, which device voxel is the maximum resolution that the additive manufacturing system (FIG. 1, 100) can address. Given that the thermal voxel is at least as big as the device voxel, it can be assured that an additive manufacturing system (FIG. 1, 100) can address each thermal voxel individually.

There are many ways that an operation of the additive manufacturing system (FIG. 1, 100) may be adjusted. For example, the build material deposition may be altered. That is, either more or less build material may be deposited or the rate at which the build material is deposited may be adjusted. For example, a gantry that moves over the bed to deposit the material may move faster or slower so as to deposit more or less build material.

As another example, an application of a fusing agent to the build material may be adjusted. For example, an agent distributor may include nozzles that operate to eject a fusing agent onto a surface in a desired pattern. In this example the nozzles may be activated or deactivated so as to expel more or less fluid as the thermal characteristics of the thermal voxel demands.

As yet another example, the application of heat to the build material may be adjusted. That is different intensities of thermal energy may be applied to the build material as demanded by the thermal voxel density.

It should be noted that in these examples, the adjustments made are at a per thermal voxel level. That is, attributes may be calculated per thermal voxel and the additive manufacturing system (FIG. 1, 100) may have a finer resolution than the thermal voxels. That is, as described above, a thermal voxel includes multiple device voxels, which device voxels represent the maximum resolution that an additive manufacturing system (FIG. 1, 100) can provide. As there are multiple device voxels in a thermal voxel, the additive manufacturing system (FIG. 1, 100) can provide differential treatment at least on the scale of the device voxel.

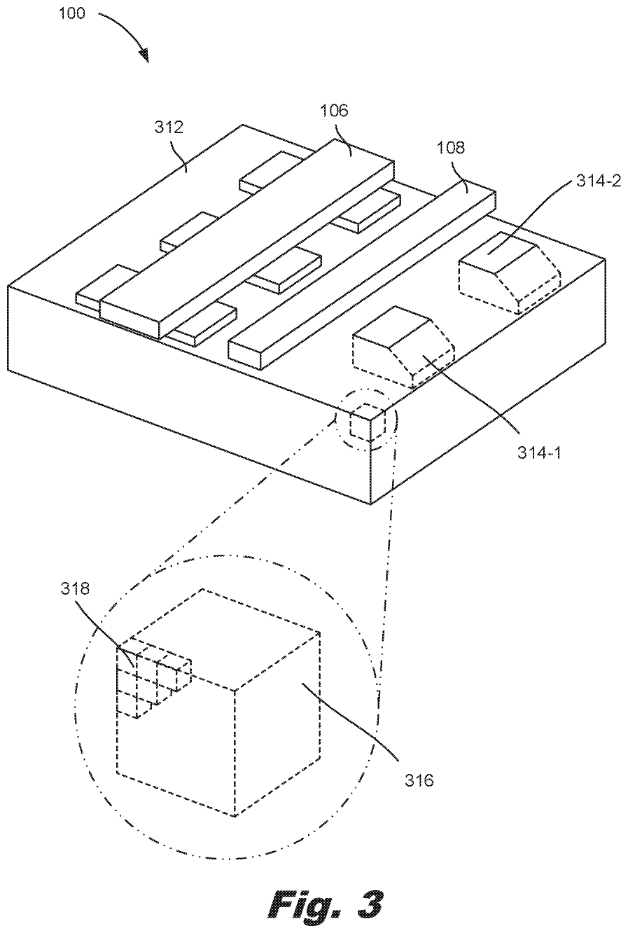

FIG. 3 is a diagram of an additive manufacturing system (100) with thermal voxel based adjustments, according to an example of the principles described herein. For simplicity, certain components such as the bed and build material distributor (FIG. 1, 104) have been omitted.

As described above, the bed receives successive layers of build material (312). As the build material is deposited a heater (106) passes over the build material (312) to selectively harden certain portions of the material to generate a printed object (314-1, 314-2). In FIG. 3, portions of the printed object (314-1, 314-2) are indicated in dashed lines indicating their position below the most recent deposited layer of build material.

In some examples, the heater (106) increases the thermal absorption of the build material (312) that is to form the 3D printed object (314-1, 314-2) via an applied fusing agent to those portions that are to form the 3D printed object (314-1, 314-2).

FIG. 3 also clearly depicts the profile determiner (108) that either statically or while moving over the bed performs surface metrology to identify, and count, the particles that make up the top layer of the build material.

FIG. 3 also clearly depicts the relationship between a thermal voxel (316), a device voxel (318), and the layer of the build material (312). As described above, the layer of the build material (312) is made up of multiple thermal voxels (316) each thermal voxel being a region of space wherein particular thermal effects of interest are constant. The dimensions of such thermal voxels (316) vary depending on 1) the hardware capabilities of the additive manufacturing system (100) and 2) the thermal effects of interest. The thermal voxel (316) also represents the resolution to which adjustments to operating parameters are made. That is, the build material in one thermal voxel (316) is treated the same, but may vary between adjacent thermal voxels (316).

As noted above, the thermal voxel (316) is at least the same size as the device voxel (318), a device voxel (318) being the smallest individually addressable region of the additive manufacturing system (100). While FIG. 3 depicts a particular size relationship between the thermal voxel (316) and the device voxels (318), any relationship may exist. For example, the thermal voxel (316) may be the same size as the device voxel (318). Allowing for the variation of thermal voxel (316) dimensions allows for a customized adjustment which may be based on 1) thermal conditions and/or 2) desired uniformity. For example, if more uniformity is desired, a smaller thermal voxel (316) dimension may be selected, at the expense of a larger calculation time. However, if less uniformity is acceptable, then a larger thermal voxel (316) may be used to accommodate a quicker manufacturing operation.

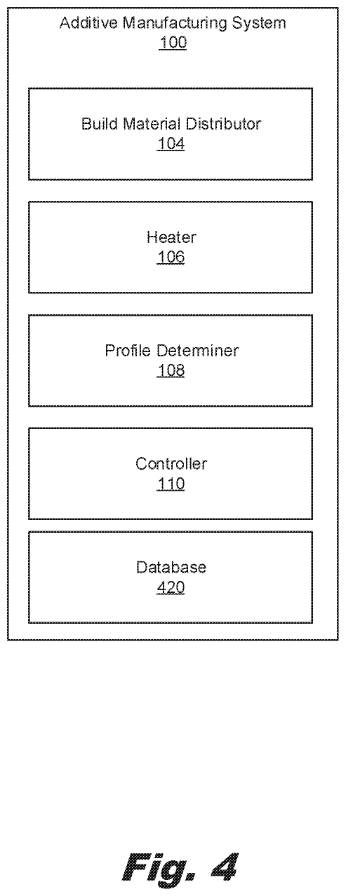

FIG. 4 is a block diagram of an additive manufacturing system (100) with thermal voxel based adjustments, according to another example of the principles described herein. As in previous examples, the additive manufacturing system (100) includes a build material distributor (104), heater (106), profile determiner (108), and controller (110). In this example, the additive manufacturing system (100) includes additional components. Specifically, the additive manufacturing system (100) includes a database (420) that maps thermal voxel attribute values to thermal diffusivity and adjustments to be made to the operation of the additive manufacturing system (100). For example, as described above, there may be a relationship between packing density and thermal diffusivity. This relationship may be stored in the database (420) and drawn from. In some examples, the thermal diffusivity may be per thermal effect. For example, the database (420) may include a mapping between an attribute of a particular thermal voxel (FIG. 3, 316) and the convective heat transfer loss coefficient.

The database (420) may also have a mapping between thermal diffusivity and/or attribute values and adjustments to be made. For example, once a thermal diffusivity is identified for each thermal voxel, the database (420) may be relied on to determine which component, or combination of components, of the additive manufacturing system (100) to adjust, and to what degree.

In some examples, the controller (110) may be a machine-learning controller (110). That is, the generated mappings between attributes and thermal diffusivity may be empirically determined over a period of time using machine learning systems, for example, kernel based regression systems and artificial neural network based systems. Similarly, the mappings between 1) attributes and/or thermal diffusivity and 2) operational adjustments may similarly be made empirically. For example, the controller (FIG. 1, 110) may model multiple thermal voxel attribute values to thermal diffusivity and adjustments to be made to the operations of the additive manufacturing system (FIG. 1, 100).

As a specific example, the build material powder may have differently shaped particles and the shapes of the particles affect the surface area provided within a given volume. The surface area of the volume affects how the particles within that region receive energy. That is, a higher surface area within a particular thermal voxel (FIG. 3, 316), the greater fluid retention. In the specific example of a multi jet fusion additive manufacturing system (FIG. 1, 100), greater fluid retention indicates that build material will absorb more thermal energy. In this example, experiments may be carried out via droplet coating simulations. In this example, the machine-learning controller (110) facilitates the development of such a relationship.

In another example, the machine-learning controller (110) over the course of time and various empirical experiments may model a relationship between packing density into a thermal conductivity control volume and further model a thermal diffusivity for this control volume.

In yet another example, the machine-learning controller (110) over the course of time and various empirical experiments may model a relationship between packing density and a convective heat transfer model a thermal diffusivity for a thermal voxel.

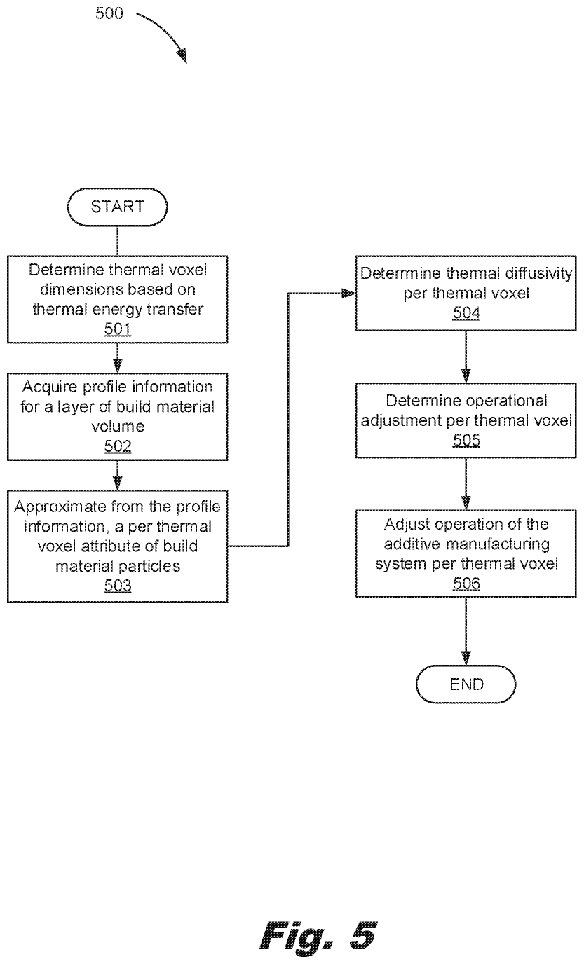

FIG. 5 is a flowchart of a method (500) for thermal voxel based additive manufacturing adjustments, according to an example of the principles described herein. According to the method (500), a thermal voxel (FIG. 3, 316) size is determined (block 501). The thermal voxel (FIG. 3, 316) size is determined based on the at least one thermal energy transfer mechanism. That is, there are various thermal energy transfer mechanisms that may affect the physical form of the build material particles. Accordingly, it may be desired to adjust the operation of the additive manufacturing system (FIG. 1, 100) to account for the effects of these thermal energy transfer mechanisms. Examples of such mechanisms include thermal fusion, which refers to the heat absorption from the heater (FIG. 1, 106). Another example is thermal conduction wherein heat energy from one particle bleeds onto an adjacent particle. Another example is thermal convection which is when thermal energy is transferred from a particle to the surrounding air. Other examples of thermal energy transfer mechanisms include thermal radiation and thermal evaporation. In some examples, the dimensions, or size, of the thermal voxel (FIG. 3, 316) may be determined based on any one of these thermal energy transfer mechanisms, or in some cases based on multiple thermal energy transfer mechanisms.

Then, during additive manufacturing, profile information for a layer of the build material (FIG. 3, 312) may be acquired (block 502) and a per-thermal voxel attribute approximated (block 503) as described above in connection with FIG. 2. The attribute may be represented in different forms such as a percentage or floating point representation. For example, the packing density may be represented as a percentage of the total volume of particles within a device voxel (FIG. 3, 318). For example, one particle in a device voxel (FIG. 3, 318) may be represented as a 1 and no particles in a device voxel (FIG. 3, 318) may be represented as a 0. These may be combined to represent a total packing density for the thermal voxel (FIG. 3, 316). In another example, the attributes may be a floating point representation of the volumetric percentage.

With the per thermal voxel attribute approximated (block 503), the controller (FIG. 1, 110) determines (block 504) a thermal diffusivity per thermal voxel (FIG. 3, 316). That is, as described above, the database (FIG. 4, 420) may include a mapping between attributes and thermal diffusivity. The controller (FIG. 1, 110) may consult the database (FIG. 4, 420) and from the approximated attributes, determine (block 504) the thermal diffusivity. Using the thermal diffusivity, the controller (FIG. 1, 110) determines (block 505) an operational adjustment, again per thermal voxel (FIG. 3, 316). Again, the controller (FIG. 1, 110) may rely on the database (FIG. 4, 420) and the determined thermal diffusivity of the thermal voxel (FIG. 3, 316) to determine what component of the additive manufacturing system (FIG. 1, 100) to adjust and to what degree. The controller (FIG. 1, 110) may then adjust (block 506) the operation of the additive manufacturing system (FIG. 1, 100) as proscribed.

In summary, using such an additive manufacturing device 1) provides real-time sensing data used for additive manufacturing adjustment to ensure thermal uniformity across a surface of the build material volume; 2) provides closed-loop feedback for the additive manufacturing device; 3) provides a more stable sintering/heating process; 4) is customizable per material and additive manufacturing system characteristics; and 5) does not result in sacrificial parts. However, the devices disclosed herein may address other matters and deficiencies in a number of technical areas.

What is claimed is:

1. A method, comprising:
acquiring profile information for a layer of a volume of build material in an additive manufacturing system;
approximating from the profile information, a per thermal voxel attribute of build material particles; and
adjusting an operation of the additive manufacturing system based on an approximated per thermal voxel attribute.

2. The method of claim 1, wherein adjusting an operation of the additive manufacturing system comprises adjusting at least one of:
a deposition of the build material;
an application of a fusing agent to the build material; and
an application of heat to the build material.

3. The method of claim 1, further comprising determining a thermal voxel size based on at least one thermal energy transfer mechanism for an additive manufacturing system.

4. The method of claim 3, wherein a thermal voxel is defined in part as a volume wherein the at least one thermal energy transfer mechanism does not change.

5. The method of claim 1, wherein the per thermal voxel attribute is selected from the group consisting of:
a per thermal voxel packing density;
a per thermal voxel surface area;
a per thermal voxel surface energy;
a per thermal voxel particle size distribution; and
a per thermal voxel exposed surface area.

6. An additive manufacturing system, comprising:
a build material distributor to successively deposit layers of build material onto a bed, the bed to hold a volume of build material;
at least one heater to, in a layer-wise fashion, selectively fuse portions of the build material to form an object via the application of heat to the build material in the bed;
a profile determiner to determine a profile for a layer of a volume of the build material; and
a controller to:
approximate from the profile information, a per thermal voxel attribute of build material particles; and
adjust an operation of the additive manufacturing system based on an approximated per thermal voxel attribute.

7. The additive manufacturing system of claim 6, wherein the controller adjusts the operation of the additive manufacturing system at a per thermal voxel level.

8. The additive manufacturing system of claim 6, wherein the controller approximates the per thermal voxel attribute and adjusts the operation of the additive manufacturing system during additive manufacturing.

9. The additive manufacturing system of claim 6, further comprising a database that maps thermal voxel attribute values to:
thermal diffusivity; and
adjustments to be made to the operation of the additive manufacturing system.

10. The additive manufacturing system of claim 6, wherein the profile determiner is an optical profilometer.

11. The additive manufacturing system of claim 6, wherein the controller is a machine-learning controller to generate a mapping between thermal voxel attribute values to thermal diffusivity and adjustments to be made to the operation of the additive manufacturing system, based on historical data.

12. A method, comprising:
determining a thermal voxel size based on a thermal energy transfer mechanism for an additive manufacturing system;
during additive manufacturing:
acquiring profile information for a layer of a volume of build material in a bed of the additive manufacturing system;
approximating from the profile information, a per thermal voxel attribute of build material particles; and
for each thermal voxel;
determining a thermal diffusivity;
determining an operational adjustment based on the thermal diffusivity; and
adjusting an operation of the additive manufacturing system.

13. The method of claim 12, the thermal voxel size is determined based on multiple thermal energy transfer mechanisms for the additive manufacturing system.

14. The method of claim 12, wherein acquiring profile information, approximating a per thermal voxel attribute of build material particles, and adjusting an operation of the additive manufacturing system, are performed for each deposited layer of build material.

15. The method of claim 12, wherein the thermal energy transfer mechanism is selected from the group consisting of:
thermal fusion;
thermal conduction;
thermal convection;
thermal radiation; and
thermal vaporization.
